(19) United States
(12) Patent Application Publication
(10) Pub. No.: US 2013/0311189 A1
(43) Pub. Date: Nov. 21, 2013

(54) VOICE PROCESSING APPARATUS

(71) Applicant: Yamaha Corporation, Hamamatsu-shi (JP)

(72) Inventors: Fernando Villavicencio, Hamamatsu-shi (JP); Jordi Bonada, Barcelona (ES)

(73) Assignee: Yamaha Corporation, Hamamatsu-shi (JP)

(21) Appl. No.: 13/896,192

(22) Filed: May 16, 2013

(30) Foreign Application Priority Data
May 18, 2012 (JP) 2012-115065

(51) Int. Cl. G10L 13/00

(52) U.S. Cl. CPC G10L 13/00
USPC 704/268

(57) ABSTRACT

In a voice processing apparatus, a processor performs generating a converted feature by applying a source feature of source voice to a conversion function, generating an estimated feature based on a probability that the source feature belongs to each element distribution of a mixture distribution model that approximates distribution of features of voices having different characteristics, generating a first conversion filter based on a difference between a first spectrum corresponding to the converted feature and an estimated spectrum corresponding to the estimated feature, generating a second spectrum by applying the first conversion filter to a source spectrum corresponding to the source feature, generating a second conversion filter based on a difference between the first spectrum and the second spectrum, and generating target voice by applying the first conversion filter and the second conversion filter to the source spectrum.

### BACKGROUND OF THE INVENTION

1. Technical Field of the Invention

The present invention relates to technology for processing voice.

2. Description of the Related Art

Technology for converting characteristics of voice has been proposed, for example, by F. Villacivencio and J Bonada, “Applying Voice Conversion to Concatenative Singing-Voice Synthesis”, in Proc. Of INTERSPEECH 10, vil. 1, 2010. This reference discloses technology for applying, to target voice, a conversion function based on a normal mixture distribution model that approximates probability distributions of the feature of voice of a first speaker and the feature of voice of a second speaker to thereby generate a voice corresponding to characteristics of the voice of the second speaker.

However, in the above mentioned technology, when voice having a feature different from that of the voice applied to generation of the conversion function (machine learning) is target voice to be processed, voice that does not correspond to the characteristics of the voice of the second speaker may be generated. Accordingly, characteristics of converted voice are unstably changed according to characteristics of the target voice (difference from voice for learning), and thus the quality of the converted voice may be deteriorated.

### SUMMARY OF THE INVENTION

In view of this, an object of the present invention is to generate voice with high quality by converting voice characteristics.

Means employed by the present invention to solve the above-described problem will be described. To facilitate understanding of the present invention, correspondence between components of the present invention and components of embodiments which will be described later is indicated by parentheses in the following description. However, the present invention is not limited to the embodiments.

A voice processing apparatus according to a first aspect of the present invention comprises a processor configured to perform: generating a converted feature (e.g. converted feature F(xA(k)) by applying a source feature (e.g. source feature xA(k)) of source voice to a conversion function (e.g. conversion function F(x)) for voice characteristic conversion, which includes a probability term representing a probability that a feature of voice belongs to each element distribution (e.g. element distribution N) of a mixture distribution model (e.g. mixture distribution model λ(z)) that approximates distribution of features of voices (e.g. source voice VS0 and target voice VT0) having different characteristics (refer to conversion unit 42); generating an estimated feature (e.g. estimated feature xB(k)) based on a probability that the source feature belongs to each element distribution of the mixture distribution model by applying the source feature to the probability term (refer to feature estimator 44); generating a first conversion filter (e.g. first conversion filter H1(k)) based on a difference between a first spectrum (e.g. first spectral envelope L1(k)) corresponding to the converted feature and an estimated spectrum (e.g. estimated spectral envelope EB(k)) corresponding to the estimated feature (refer to first difference calculator 52); generating a second spectrum (e.g. second spectral envelope L2(k)) by applying the first conversion filter to a source spectrum (e.g. source spectral envelope EA(k)) corresponding to the source feature (refer to synthesizing unit 54); generating a second conversion filter (e.g. second conversion filter H2(k)) based on a difference between the first spectrum and the second spectrum (refer to second difference calculator 56); and generating target voice by applying the first conversion filter and the second conversion filter to the source spectrum (refer to voice converter 32).

In the voice processing apparatus according to the first aspect of the present invention, the first conversion filter is generated based on the difference between the estimated feature obtained by applying the source feature to the probability term of the conversion function and the converted feature obtained by applying the source feature to the conversion function, and the second conversion filter is generated based on the difference between the first spectrum represented by the converted feature and the second spectrum obtained by applying the first conversion filter to the source spectrum of the source feature. The target voice is generated by applying the first conversion filter and the second conversion filter to the spectrum of the source voice VS. The second conversion filter operates such that the difference between the source feature and the estimated feature is compensated, and thus high-quality voice can be generated even when the source feature is different from the feature of voice for setting the conversion function.

According to a preferred aspect of the present invention, the processor performs: smoothing the first spectrum and the second spectrum in a frequency domain thereof (refer to smoothing unit 562); and calculating a difference between the smoothed first spectrum (e.g. first smoothed spectral envelope LS1(k)) and the smoothed second spectrum (e.g. second smoothed spectral envelope LS2(k)) as the second conversion filter (refer to subtractor 564).

In this configuration, since the difference between the smoothed first spectrum and the smoothed second spectrum is calculated as the second conversion filter, it is possible to accurately compensate for the difference between the source feature and the estimated feature.

In a second aspect of the present invention, the processor further performs: sequentially selecting a plurality of phonemes as the source voice, so that each phoneme selected as the source voice is processed by the processor to sequentially generate a plurality of phonemes as the target voice; and connecting the plurality of the phonemes each generated as the target voice to synthesize an audio signal.

According to this configuration, the same effect as the voice processing apparatus according to the first aspect of the invention can be achieved.

The voice processing apparatuses according to the first and second aspects of the present invention are implemented by not only an electronic circuit such as a DSP (Digital Signal Processor) dedicated for voice processing but also cooperation of a general-use processing unit such as a CPU (Central Processing Unit) and a program. For example, a program according to the first aspect of the present invention executes, on a computer, a conversion process (S21) for generating a converted feature by applying a source feature of source voice to a conversion function for voice characteristic conversion, which includes a probability term representing a probability that a feature of voice belongs to each element distribution of a mixture distribution model that approximates distribution of features of voices having different characteristics, a feature estimation process (S22) for generating an estimated feature based on a probability that the source feature belongs to each element distribution of the mixture distribution model by applying the source feature to the probability term, a first difference calculating process (S23) for generating a first conversion filter based on a difference between a first spectrum corresponding to the converted feature generated through the conversion process and an estimated spectrum corresponding to the estimated feature generated through the feature estimation process, a synthesizing process (S24) for generating a second spectrum by applying the first conversion filter generated through the first difference calculating process to a source spectrum corresponding to the source feature, a second difference calculating process (S25) for generating a second conversion filter based on a difference between the first spectrum and the second spectrum, and a voice conversion process (S26) for generating target voice by applying the first conversion filter and the second conversion filter to the source spectrum. According to the program, the same operation and effect as those of the voice processing apparatus according to the first aspect of the present invention can be implemented.

A program according to the second aspect of the present invention executes, on a computer, a phoneme selection process for sequentially selecting a plurality of phonemes, a voice process for converting the phonemes selected by the phoneme selection process into phonemes of target voice through the same process as the program according to the first aspect of the invention, and a voice synthesis process for generating an audio voice signal by connecting the phonemes converted through the voice process.

According to the program, the same operation and effect as those of the voice processing apparatus according to the second aspect of the present invention can be implemented.

The programs according to the first and second aspects of the present invention can be stored in a computer readable non-transitory recording medium and installed in a computer, or distributed through a communication network and installed in a computer.

### BRIEF DESCRIPTION OF THE DRAWINGS

FIG. 1 is a block diagram of a voice processing apparatus according to a first embodiment of the present invention.

FIG. 2 is a flowchart illustrating operation of a feature extractor.

FIG. 3 is a block diagram of an analysis unit.

FIGS. 4A, 4B and 4C show graphs for explaining a first conversion filter.

FIG. 5 is a block diagram of a second difference calculator.

FIG. 6 is a schematic diagram illustrating operation of the second difference calculator.

FIG. 7 is a schematic diagram illustrating operation of an integration unit.

FIG. 8 is a block diagram of a voice processing apparatus according to a second embodiment of the present invention.

FIG. 9 is a flowchart showing a voice processing method according to the invention.

### DETAILED DESCRIPTION OF THE INVENTION

### First Embodiment

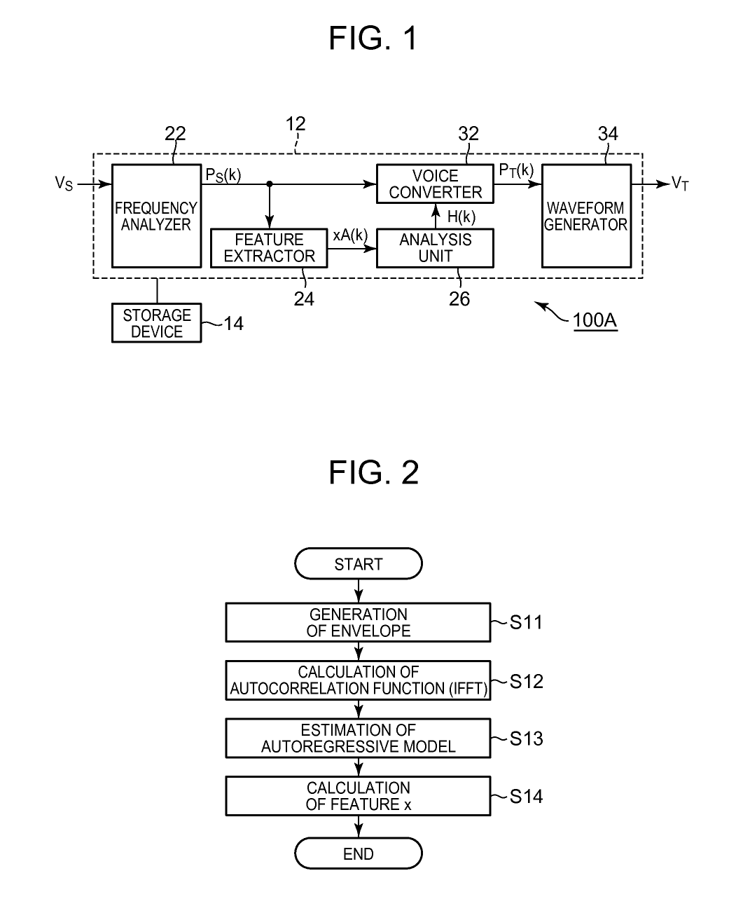

FIG. 1 is a block diagram of a voice processing apparatus 100A according to a first embodiment of the present invention. A voice signal corresponding to voice (referred to as “source voice” hereinafter) VS of a specific speaker US is supplied to the voice processing apparatus 100A. The voice processing apparatus 100A is a signal processor functioning as a voice characteristic conversion apparatus that converts the source voice VS of the speaker US into voice (referred to as “target voice” hereinafter) VT having voice characteristics of a speaker UT while maintaining the content (phonemes) of the source voice. A voice signal corresponding to the target voice VT after conversion is output from the voice processing apparatus 100A as sound wave. Voices having different characteristics, generated by a single speaker, may be the source voice VS and the target voice VT. That is, the speaker US and the speaker UT can be the same speaker.

As shown in FIG. 1, the voice processing apparatus 100A is implemented as a computer system including a processing unit 12 and a storage device 14. The storage device 14 stores programs executed by the processing unit 12 and data used by the processing unit 12. A known recording medium such as a semiconductor recording medium, a magnetic recording medium or a combination of plural types of recording media may be used as the storage device 14. The processing unit 12 implements a plurality of functions (functions of frequency analyzer 22, feature extractor 24, analysis unit 26, voice converter 32 and waveform generator 34) for converting the source voice VS of the speaker US into the target voice VT of the speaker UT by executing a program stored in the storage device 14. It is possible to employ a configuration in which the functions of the processing unit 12 are distributed to a plurality of devices or a configuration in which some functions of the processing unit 12 are implemented by a dedicated electronic circuit (DSP).

The frequency analyzer 22 sequentially calculates a spectrum (referred to as “source spectrum” hereinafter) PS(k) of the source voice VS for each unit period (frame) in the time domain. Here, k denotes a unit period in the time domain. The spectrum PS(k) is an amplitude spectrum or power spectrum, for example. A known frequency analysis method such as fast Fourier transform can be used to calculate the spectrum PS(k). Furthermore, it is possible to employ a filter bank composed of a plurality of bandpass filters having different passbands as the frequency analyzer 22.

The feature extractor 24 sequentially generates a feature (referred to as “source feature” hereinafter) xA(k) of the source voice VS for each unit period. Specifically, the feature extractor 24 according to the first embodiment of the invention executes a process shown in FIG. 2 in each unit period. Upon initiation of the process shown in FIG. 2, the feature extractor 24 specifies a spectral envelope (referred to as “source spectral envelope” hereinafter) EA(k) of the spectrum PS(k) calculated by the frequency analyzer 22 in each unit period (S11). For example, the feature extractor 24 specifies the source spectral envelope EA(k) by interpolating each peak (frequency component) of the spectrum PS(k) corresponding to each unit period. Known curve interpolation (e.g. cubic spline interpolation) is used to interpolate each peak. Low band of the source spectral envelope EA(k) may be emphasized by converting the frequency into a mel frequency (mel scaling).

The feature extractor 24 calculates an autocorrelation function by performing inverse Fourier transform on the source spectral envelope EA(k) (S12) and estimates an autoregressive model (all-pole transfer function) that approximates the source spectral envelope EA(k) from the autocorrelation function calculated by step S12 (S13). Yule-Walker equation is preferably used to estimate the autoregressive model. The feature extractor 24 calculates a vector having, as components, a plurality of coefficients (line spectrum frequency) corresponding to coefficients (autoregressive coefficients) of the autoregressive model estimated in step S13, as the source feature xA(k) (S14). As described above, the source feature xA(k) represents the source spectral envelope EA(k). Specifically, each coefficient (each line spectrum frequency) of the source feature xA(k) is set such that spacing (coarse and dense) of line spectra is changed according to the height of each peak of the source spectral envelope EA(k).

The analysis unit 26 shown in FIG. 1 sequentially generates a conversion filter H(k) for each unit period by analyzing the source feature xA(k) corresponding to each unit period, extracted by the feature extractor 24. The conversion filter H(k) is a transformation filter (mapping function) for converting the source voice VS into the target voice VT and is composed of a plurality of coefficients corresponding to frequencies in the frequency domain. The detailed configuration and operation of the analysis unit 26 will be described below.

The voice converter 32 converts the source voice VS into the target voice VT using the conversion filter H(k) generated by the analysis unit 26. Specifically, the voice converter 32 generates a spectrum PT(k) of the target voice VT in each unit period by applying the conversion filter H(k) corresponding to a unit period to the spectrum PS(k) corresponding to a unit period, generated by the frequency analyzer 22. For example, the voice converter 32 generates the spectrum PT(k) (PT(k)=PS(k)+H(k)) by summing the spectrum PS(k) of the source voice VS and the conversion filter H(k) generated by the analysis unit 26. The temporal relationship between the spectrum PS(k) of the source voice VS and the conversion filter H(K) may be appropriately changed. For example, the conversion filter H(k) corresponding to a unit period can be applied to a spectrum PS(k+1) corresponding to the next unit period.

The waveform generator 34 generates an audio vocal signal corresponding to the target voice VT from the spectrum PT(k) generated by the voice converter 32 in each unit period. Specifically, the waveform generator 34 generates the voice signal corresponding to the target voice VT by converting the spectrum PT(k) of the frequency domain into a waveform signal of the time domain and summing waveform signals of consecutive unit periods in an overlapping state. The voice signal generated by the waveform generator 34 is output as sound, for example.

A conversion function F(x) for converting the source voice VS into the target voice VT is used for generation of the conversion filter H(k) by the analysis unit 26. Prior to description of the configuration and operation of the analysis unit 26, the conversion function F(x) will now be described in detail.

To set the conversion function F(x), previously stored or provisionally sampled source voice VS0 and target voice VT0 are used as learning information (advance information). The source voice VS0 corresponds to voice generated when the speaker US sequentially speaks a plurality of phonemes, and the target voice VT0 corresponds to voice generated when the speaker UT sequentially speaks the same phonemes as those of the source voice VS0. A feature x(t) of the source voice VS0, corresponding to each unit period, and a feature y(t) of the target voice VT0, corresponding to each unit period, are extracted. The feature x(t) and feature y(t) have the same value (vector representing a spectral envelope) as the source feature xA(k) extracted by the feature extractor 24 and are extracted through the same method as the process shown in FIG. 2.

A mixture distribution model λ(z) corresponding to distributions of the feature x(t) of the source voice VS0 and the feature y(k) of the target voice VT0 is taken into account. The mixture distribution model λ(z) approximates a distribution of a feature (vector) z, which has the feature x(k) and the feature y(k) corresponding to each other in the time domain as elements, to the weighted sum of Q element distributions N, as represented by Equation (1). For example, a normal mixture distribution model (GMM: Gaussian Mixture Model) having an element distribution N as a normal distribution is preferably employed as the mixture distribution model λ(z).

$$λ ( z ) = {\sum }_{q = 1}^{Q} {α}_{q} N ( z ; {μ}_{q}^{z} , {\sum }_{q}^{z} ) \\ ( {\sum }_{q = 1}^{Q} {α}_{q} = 1 , {α}_{q} \geq 0 ) \qquad ( 1 )$$

In Equation (1), α_{q} denotes the weighted sum of q-th (q=1 to Q) element distribution N, μ_{q}^{z} denotes the average (average vector) of the q-th element distribution N, and Σ_{q}^{z} denotes the covariance matrix of the q-th element distribution N. A known maximum likelihood estimation algorithm such as EM (Expectation-Maximization) algorithm is employed to estimate the mixture distribution model λ(z) of Equation (1). When the total number of element distributions N is set to an appropriate value, there is a high possibility that the element distributions N of the mixture distribution model λ(z) correspond to different phonemes.

The average μ_{q}^{z} of the q-th element distribution N includes the average μ_{q}^{x} of the feature x(k) and the average μ_{q}^{y} of the feature y(k), as represented by Equation (2).

μ_{q}^{z}=[μ_{q}^{x}μ_{q}^{y}] (2)

The covariance matrix Σ_{q}^{z} of the q-th element distribution n is represented by Equation (3).

$${\sum }_{q}^{z} = [ \begin{matrix}{\sum }_{q}^{xx} & {\sum }_{q}^{xy} \\ {\sum }_{q}^{yx} & {\sum }_{q}^{yy}\end{matrix} ] \qquad ( 3 )$$

In Equation (3), Σ_{q}^{xx} denotes a covariance matrix (autocovariance matrix) of each feature x(k) in the q-th element distribution N, Σ_{q}^{yy} denotes a covariance matrix (autocovariance matrix) of each feature y(k) in the q-th element distribution N, and Σ_{q}^{xy} and Σ_{q}^{yx} respectively denote covariance matrices (cross-covariance matrices) of features x(k) and y(x) in the q-th element distribution N.

The conversion function F(x) applied by the analysis unit 26 to generation of the conversion filter H(k) is represented by Equation (4).

$$F ( x ) = E ( y \vert x ) = {\sum }_{q = 1}^{Q} ( {μ}_{q}^{y} + {\sum }_{q}^{yx} {( {\sum }_{q}^{xx} )}^{- 1} ( x - {μ}_{q}^{x} ) ) \cdot p ( {c}_{q} \vert x ) \qquad ( 4 )$$

In Equation (4), p(c_{q}|x) denotes a probability term representing a probability (posteriori probability) that a feature x belongs to the q-th element distribution N of the mixture distribution model λ(z) when the feature x is observed and is defined by Equation (5).

$$p ( {c}_{q} \vert x ) = \frac{{α}_{q} N ( x ; {μ}_{q}^{x} , {\sum }_{q}^{xx} )}{{\sum }_{p = 1}^{Q} {α}_{p} N ( x ; {μ}_{p}^{x} , {\sum }_{p}^{xx} )} \qquad ( 5 )$$

The conversion function F(x) of Equation (4) represents mapping from a space (referred to as “source space” hereinafter) corresponding to the source voice VS of the speaker US to another space (referred to as “target space” hereinafter) corresponding to the target voice VT of the speaker UT. That is, an estimate F(xA(k)) of the feature of the target voice VT, which corresponds to the source feature xA(k), is calculated by applying the source feature xA(k) extracted by the feature extractor 24 to the conversion function F(x). The source feature xA(k) extracted by the feature extractor 24 may be different from the feature x(k) of the source voice VS0 used to set the conversion function F(x). Mapping of the source feature xA(k) according to the conversion function F(x) corresponds to a process of converting (mapping) a feature (estimated feature) xB(k) (xB(k)=p(cq|xA(k))xA(k)), obtained by representing the source feature xA(k) in the source space according to the probability term p(cqlx), to the target space.

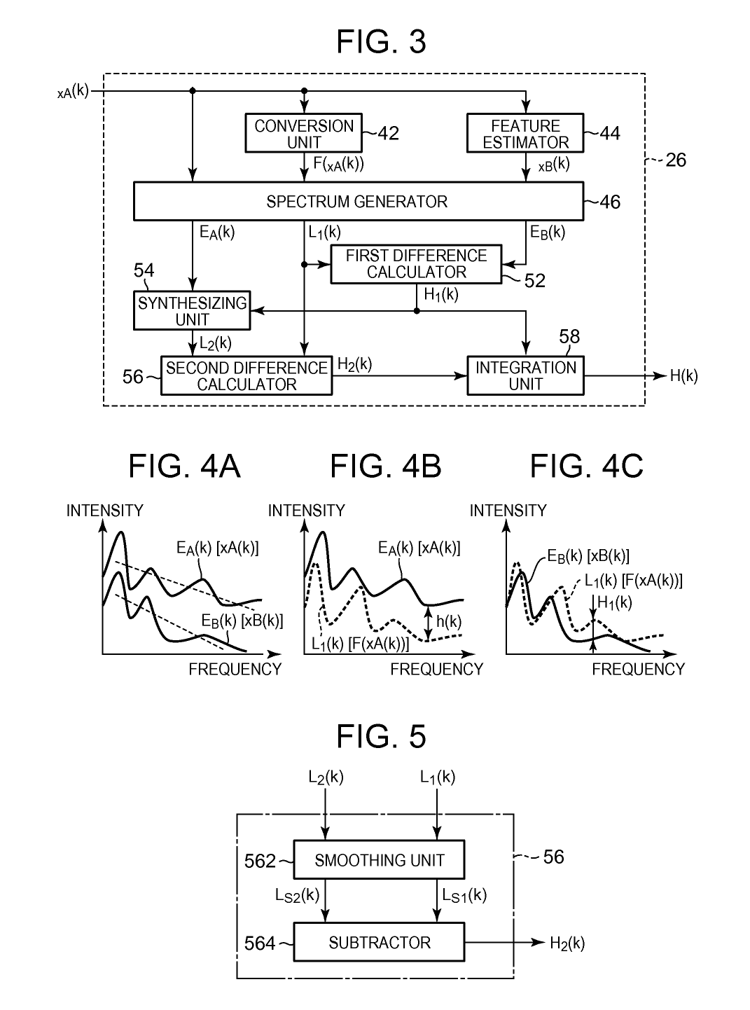

The averages μ_{q}^{x} and μ_{q}^{y} of Equation (2) and the covariance matrices Σ_{q}^{xx} and Σ_{q}^{yx} of Equation (3) are calculated using each feature x(k) of the source voice VS0 and each feature y(k) of the target voice VT0 as learning information and stored in the storage device 14. The analysis unit 26 shown in FIG. 1 uses the conversion function F(x), obtained by applying the variables μ_{q}^{x}, μ_{q}^{y}, Σ_{q}^{xx} and Σ_{q}^{yx} stored in the storage device 14 to Equation (4), to generate the conversion filter H(k). FIG. 3 is a block diagram of the analysis unit 26. As shown in FIG. 3, the analysis unit 26 includes a conversion unit 42, a feature estimator 44, a spectrum generator 46, a first difference calculator 52, a synthesizing unit 54, a second difference calculator and an integration unit 58.

The conversion unit 42 calculates the converted feature F(xA(k)) for each unit period by applying the source feature xA(k) extracted by the feature extractor 24 for each unit period to the conversion function F(x) of Equation (4). That is, the converted feature F(xA(k)) corresponds to an estimate of the feature of the target voice VT or predicted feature thereof, which corresponds to the source feature xA(k).

The feature estimator 44 calculates the estimated feature xB(k) for each unit period by applying the source feature xA(k) extracted by the feature extractor 24 for each unit period to the probability term p(cq|x) of the conversion function F(x). The estimated feature xB(k) represents a predicted point (specifically, a point at which the likelihood that a phoneme corresponds to the source feature xA(k) is statistically high) corresponding to the source feature xA(k) in the source space of the source voice VS0 used to set the conversion function F(x). That is, the estimated feature xB(k) corresponds to a model of the source feature xA(k) represented in the source space. The feature estimator 44 according to the present embodiment calculates the estimated feature xB(k) according to Equation (6) using the average μ_{q}^{x} stored in the storage device 14.

$$xB ( k ) = {\sum }_{q = 1}^{Q} {μ}_{q}^{x} p ( {c}_{q} \vert xA ( k ) ) \qquad ( 6 )$$

FIG. 4A shows the source spectral envelope EA(k) represented by the source feature xA(k) and a spectral envelope (referred to as “estimated spectral envelope” hereinafter) represented by the estimated feature xB(k). Since there is a high possibility that the source feature xA(k) and the estimated feature xB(k) belong to a common element distribution N corresponding to one phoneme, peaks of the source spectral envelope EA(k) approximately correspond to peaks of the estimated spectral envelope EB(k) in the frequency domain, as shown in FIG. 4A. However, when there is a difference between the source feature xA(k) and the previously sampled feature x(k) of the source voice VS0 for setting the conversion function F(x), an approximate gradation and intensity level of the source spectral envelope EA(k) with respect to frequency may be different from those of the estimated spectral envelope EB(k).

The spectrum generator 46 shown in FIG. 3 converts the features xA(k), F(xA(k)) and xB(k) into spectral envelopes (spectral densities). Specifically, the spectrum generator 46 generates the source spectral envelope EA(k) represented by the source feature xA(k) extracted by the feature extractor 24, a first spectral envelope L1(k) representing the converted feature F(xA(k)) generated by the conversion unit 42, and the estimated spectral envelope EB(k) representing the estimated feature xB(k) generated by the feature estimator 44, which correspond to each unit period. FIG. 4B shows the source spectral envelope EA(k) representing the source feature xA(k) and the first spectral envelope L1(k) representing the converted feature F(xA(k)).

The first difference calculator 52 shown in FIG. 3 sequentially generates a first conversion filter H1(k) based on a difference between the first spectral envelope L1(k) corresponding to the converted feature F(xA(k)) and the estimated spectral envelope EB(k) corresponding to the estimated feature xB(k) for respective unit periods. Specifically, the first difference calculator 52 generates the first conversion filter H1(k) (H1(k)=L1(k)-EB(k)) by subtracting the estimated spectral envelope EB(k) from the first spectral envelope L1(k) in the frequency domain, as shown in FIG. 4C. As can be seen from the above description, the first conversion filter H1(k) is a transformation filter (conversion function) for mapping the estimated feature xB(k) in the source space to the target space.

The synthesizing unit 54 shown in FIG. 3 sequentially generates a second spectral envelope L2(k) for respective unit periods by applying the first conversion filter H1(k) generated by the first difference calculator 52 to the source spectral envelope EA(k) of the source feature xA(k). Specifically, the synthesizing unit 54 generates the second spectral envelope L2(k) (L2(k)=EA(k)+H1(k)) by summing the source spectral envelope EA(k) and the first conversion filter H1(k) in the frequency domain.

The second difference calculator 56 sequentially generates a second conversion filter H2(k) based on the difference between the first spectral envelope L1(k) corresponding to the converted feature F(xA(k)) generated by the conversion unit 42 and the second spectral envelope L2(k) generated by the synthesizing unit 54 for respective unit period.

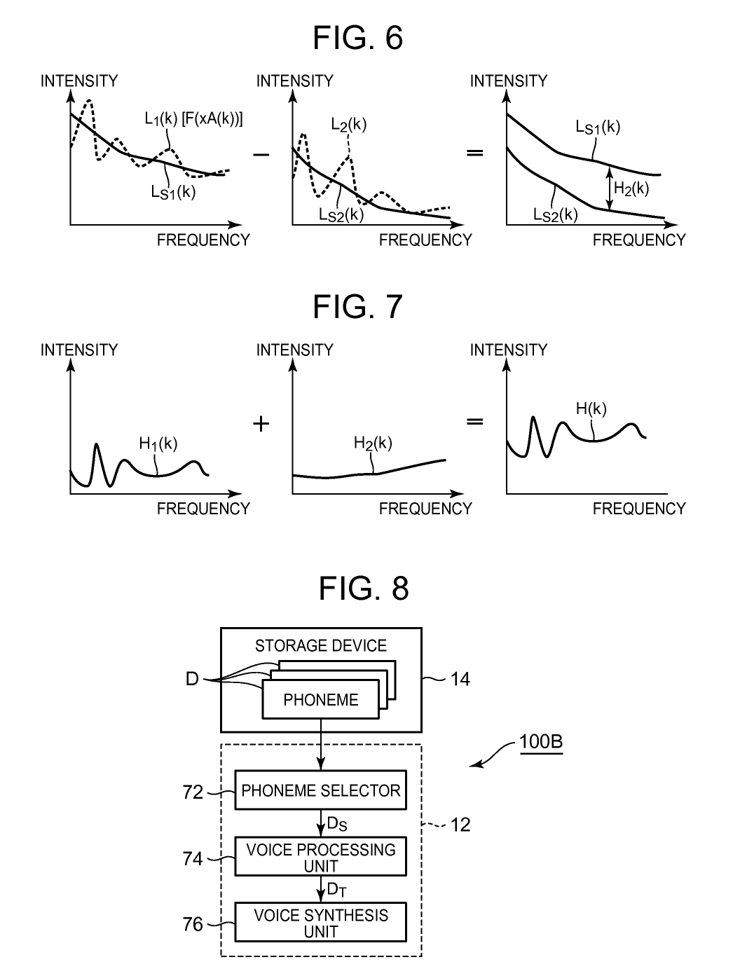

FIG. 5 is a block diagram of the second difference calculator 56 and FIG. 6 shows graphs for explaining a process performed by the second difference calculator 56. As shown in FIG. 5, the second difference calculator 56 according to the first embodiment of the invention includes a smoothing unit 562 and a subtractor 564. As shown in FIG. 6, the smoothing unit 562 smoothes the first spectral envelope L1(k) in the frequency domain to sequentially generate a first smoothed spectral envelope LS1(k) for respective periods and smoothes the second spectral envelope L2(k) in the frequency domain to sequentially generate a second smoothened spectral envelope LS2(k) for respective unit periods. For example, the smoothing unit 562 suppresses fine structures before smoothing to generate the first smoothed spectral envelope LS1(k) and the second smoothed spectral envelope LS2(k) by calculating a moving average (simple moving average or weighted moving average) over five frequencies in the frequency domain.

The subtractor 564 shown in FIG. 5 sequentially calculates the difference between the first smoothed spectral envelope LS1(k) and the second smoothed spectral envelope LS2(k) as the second conversion filter H2(k) (H2(k)=LS1(k)−LS2(k)) for respective unit periods, as shown in FIG. 6. The difference between the first spectral envelope L1(k) and the second spectral envelope L2(k) (difference between the first smoothed spectral envelope LS1(k) and the second smoothed spectral envelope LS2(k)) corresponds to the difference between the source feature xA(k) and the estimated feature xB(k) (intensity level and gradient differences). Accordingly, the second conversion filter H2(k) functions as an adjustment filter (conversion function) for compensating for the difference between the source feature xA(k) and the estimated feature xB(k).

The integration unit 58 shown in FIG. 3 generates the conversion filter H(k) based on the first conversion filter H1(k) generated by the first difference calculator 52 and the second conversion filter H2(k) generated by the second difference calculator 56. Specifically, the integration unit 58 sequentially generates the conversion filter H(k) (H(k)=H1(k)+H2(k)) for respective unit periods by summing the first conversion filter H1(k) and the second conversion filter H2(k), as shown in FIG. 7. As described above, the conversion filter H(k) generated by the integration unit 58 is applied to the spectrum PS(k) of the source voice VS by the voice converter 32 shown in FIG. 1 to generate the spectrum PT(k) of the target voice VT.

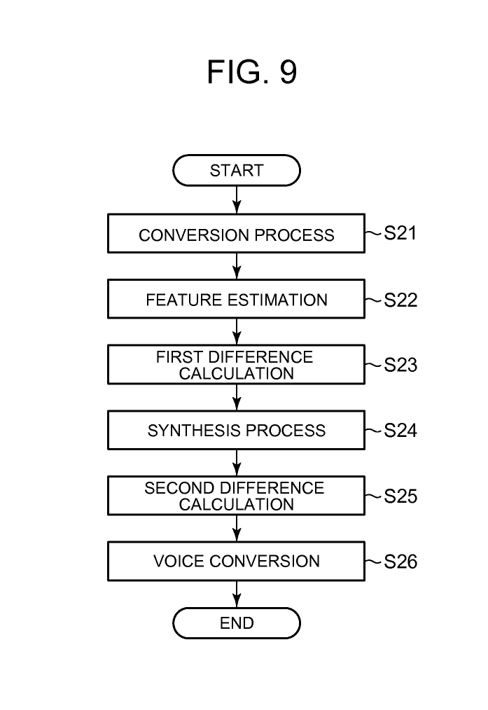

FIG. 9 is a flowchart showing a voice processing method performed by the voice processing apparatus 100A. At step S21, conversion process is performed for generating a converted feature (e.g. converted feature F(xA(k)) by applying a source feature (e.g. source feature A(k)) of source voice to a conversion function (e.g. conversion function F(x)) for voice characteristic conversion, which includes a probability term representing a probability that a feature of voice belongs to each element distribution (e.g. element distribution N) of a mixture distribution model (e.g. mixture distribution model λ(z)) that approximates distribution of features of voices (e.g. source voice VS0 and target voice VT0) having different characteristics.

At step S22, feature estimation is performed for generating an estimated feature (e.g. estimated feature xB(k)) based on a probability that the source feature belongs to each element distribution of the mixture distribution model by applying the source feature to the probability term.

At step S23, first difference calculation is performed for generating a first conversion filter (e.g. first conversion filter H1(k)) based on a difference between a first spectrum (e.g. first spectral envelope L1(k)) corresponding to the converted feature and an estimated spectrum (e.g. estimated spectral envelope EB(k)) corresponding to the estimated feature.

At step S24, synthesis process is performed for generating a second spectrum (e.g. second spectral envelope L2(k)) by applying the first conversion filter to a source spectrum (e.g. source spectral envelope EA(k)) corresponding to the source feature.

At step S25, second difference calculation is performed for generating a second conversion filter (e.g. second conversion filter H2(k)) based on a difference between the first spectrum and the second spectrum.

At step S26, voice conversion is performed for generating target voice by applying the first conversion filter and the second conversion filter to the source spectrum.

A configuration (referred to as “comparative example” hereinafter) in which the difference between the first spectral envelope L1(k) of the converted feature F(xA(k)) obtained by applying the source feature xA(k) to the conversion function F(x) and the source spectral envelope EA(k) of the source feature xA(k) is applied as a conversion filter h(k) (h(k)=L1(k)−EA(k)) to the spectrum PS(k) of the source voice VS (PT(k)=PS(k)+h(k)) can be considered as a configuration for converting the source voice VS into the target voice VT. In the comparative example, however, when the source feature xA(k) is different from the estimated feature xB(k) used as learning information when the conversion function F(x) is set, the difference between the source feature xA(k) and the estimated feature xB(k) assumed by mapping according to the conversion function F(x) increases, and thus a voice different from the original voice characteristics of the target voice VT may be generated. Furthermore, since the difference between the source feature xA(k) and the estimated feature xB(k) is varied according to the source feature xA(k), the conversion filter h(k) is unstably changed, and thus characteristics of converted voice are frequently changed, deteriorating sound quality.

The first conversion filter H1(k) is generated based on the difference between the estimated feature xB(k) obtained by applying the source feature xA(k) to the probability term p(cq|x) of the conversion function F(x) and the converted feature F(xA(k)) obtained by applying the conversion function F(x) to the source feature xA(k) in the first embodiment of the invention, and the second conversion filter H2(k) is generated based on the difference between the first spectral envelope L1(k) represented by the converted feature F(xA(k)) and the second spectral envelope L2(k) obtained by applying the first conversion filter H1(k) to the source spectral envelope EA(k) of the source feature xA(k). In addition, the spectrum PT(k) of the target voice VT is generated by applying the first conversion filter H1(k) and the second conversion filter H2(k) to the spectrum PS(k) of the source voice VS. Since the second conversion filter H2(k) compensates for the difference between the source feature xA(k) and the estimated feature xB(k), a high quality voice can be generated compared to the above-described comparative example even when the source feature xA(k) is different from the feature x(k) of the source voice VS0 for setting the conversion function F(x).

In the first embodiment of the present invention, the second conversion filter H2(k) is generated based on the difference between the first smoothed spectral envelope LS1(k) obtained by smoothing the first spectral envelope L1(k) and the second smoothed spectral envelope LS2(k) obtained by smoothing the second spectral envelope L2(k). Accordingly, it is possible to compensate for the difference between the source feature xA(k) and the estimated feature xB(k) with high accuracy to generate the target voice VT with high quality, compared to the configuration in which the second conversion filter H2(k) is generated based on the difference between the first spectral enveloped L1(k) and the second spectral envelope L2(k).

### Second Embodiment

A second embodiment of the present invention will now be described. In the following embodiments, components having the same operations and functions as those of corresponding components in the first embodiment are denoted by the same reference numerals and detailed description thereof is omitted.

FIG. 8 is a block diagram of a voice processing apparatus 100B according to the second embodiment of the present invention. The voice processing apparatus 100B according to the second embodiment of the present invention is a signal processor (voice synthesizer) that generates a voice signal by connecting a plurality of phonemes. A user can selectively generate a voice having voice characteristics of the speaker US and a voice having voice characteristics of the speaker UT by appropriately manipulating an input device (not shown).

As shown in FIG. 8, a set (library for voice synthesis) of a plurality of phonemes D extracted from the source voice VS of the speaker US is stored in the storage device 14. Each phoneme is a monophone corresponding to a minimum unit (e.g. vowel and consonant) that discriminates linguistic meanings, or a diphone (triphone) corresponding to a sequence of monophones and is represented by data that defines sample series of waveform in the time domain and a spectrum in the frequency domain, for example.

The processing unit 12 according to the second embodiment of the invention performs a plurality of functions (functions of a phoneme selector 72, a voice processing unit 74 and a voice synthesis unit 76) by executing a program stored in the storage device 14. The phoneme selector 72 sequentially selects a phoneme DS corresponding to a sound generating character (referred to as “designated phoneme” hereinafter) such as lyrics designated to a synthesis target.

The voice processing unit 74 converts each phoneme D (source voice VS) selected by the phoneme selector 72 into a phoneme DT of the target voice VT of the speaker UT.

Specifically, the voice processing unit 74 performs conversion of each phoneme D when instructed to synthesize a voice of the speaker UT. More specifically, the voice processing unit 74 generates a phoneme DT of the target voice VT from the phoneme DS of the source voice VS through the same process as conversion of the source voice VS into the target voice VT by the voice processor 100A according to the first embodiment of the invention. That is, the voice processing unit 74 according to the second embodiment of the invention includes the frequency analyzer 22, the feature extractor 24, the analysis unit 26, the voice converter 32, and the waveform generator 34. Accordingly, the second embodiment can achieve the same effect as that of the first embodiment. When synthesis of a voice of the speaker US is instructed, the voice processing unit 74 stops operation thereof.

The voice synthesis unit 76 shown in FIG. 8 generates an audio vocal signal (voice signal corresponding to a voice generated when the speaker US speaks the designated phoneme) by adjusting the pitch of phonemes DS (source voice VS of the speaker US) selected and acquired from the storage device 14 by the phoneme selector 72 with high accuracy and by connecting the phonemes D when synthesis of the voice of the speaker US is instructed. When synthesis of a voice of the speaker UT is instructed, the voice synthesis unit 76 adjusts the pitch of phonemes DT (target voice VT of speaker UT) converted by the voice processing unit 74 and then connecting the phonemes D to generate a voice signal (voice signal corresponding to a voice generated when the speaker UT sounds the designated phoneme).

In the second embodiment described above, since phonemes D extracted from the source sound VS of the speaker US are converted into phonemes D of the target voice VT and then applied to voice synthesis, it is possible to synthesize a voice of the speaker UT even if the phonemes D of the speaker UT are not stored in the storage device 14. Accordingly, capacity of the storage device 14, required to synthesize the voice of the speaker US and the voice of the speaker UT, can be reduced compared to the configuration in which both the phonemes D of the speaker US and phonemes D of the speaker UK are stored in the storage device.

### Modifications

The above-described embodiments can be modified in various manners. Detailed modifications will now be described. Two or more arbitrary embodiments selected from the following examples can be appropriately combined.

(1) While the integration unit 58 of the analysis unit 26 generates the conversion filter H(k) by integrating the first conversion filter H1(k) and the second conversion filter H2(k), it may be possible to generate the spectrum PT(k) (PT(k)=PS(k)−H1(k)+H2(k)) of the target voice VT in each unit period by applying the first conversion filter H1(k) generated by the first difference calculator 52 and the second conversion filter H2(k) generated by the second difference calculator 56 to the spectrum PS(k) corresponding to each unit period by the voice converter 32. That is, the integration unit 58 is omitted. As can be understood from the above description, the voice converter 32 according to the above-described embodiments is included as a component (voice conversion means) that generates the target voice VT by applying the first conversion filter H1(k) and the second conversion filter H2(k) to the spectrum PS(k) irrespective of presence or absence of integration (generation of the conversion filter H(k)) of the first conversion filter H1(k) and the second conversion filter H2(k).

(2) While the second conversion filter H2(k) is generated based on the difference between the first smoothed spectral envelope LS1(k) obtained by smoothing the first spectral envelope L1(k) and the second smoothed spectral envelope LS2(k) obtained by smoothing the second spectral envelope L2(k) in the above-described embodiments, smoothing of the first spectral envelope L1(k) and the smoothing of the second spectral envelope L2(k) (smoothening unit 562) may be omitted. That is, the second difference calculator 56 according to the above-described embodiments is included as a component (second difference calculation means) for generating the second conversion filter H2(k) based on the difference between the first spectral envelope L1(k) and the second spectral envelope L2(k).

(3) While series of a plurality of coefficients that define the line spectrum of an autoregressive model are exemplified as features xA(k) and xB(k) in the above-described embodiments, feature types are not limited thereto. For example, a configuration using an MFCC (Mel-frequency cepstral coefficient) as a feature can be employed. Moreover, Cepstrum or Line Spectral Frequencies (LSF, other name “Line Spectral Pairs (LSP)”) may be used other than MFCC.

What is claimed is:

1. A voice processing apparatus comprising a processor configured to perform:
generating a converted feature by applying a source feature of source voice to a conversion function for voice characteristic conversion, the conversion function including a probability term representing a probability that a feature of voice belongs to each element distribution of a mixture distribution model that approximates distribution of features of voices having different characteristics;
generating an estimated feature based on a probability that the source feature belongs to each element distribution of the mixture distribution model by applying the source feature to the probability term;
generating a first conversion filter based on a difference between a first spectrum corresponding to the converted feature and an estimated spectrum corresponding to the estimated feature;
generating a second spectrum by applying the first conversion filter to a source spectrum corresponding to the source feature;
generating a second conversion filter based on a difference between the first spectrum and the second spectrum; and
generating target voice by applying the first conversion filter and the second conversion filter to the source spectrum.

2. The voice processing apparatus according to claim 1, wherein the processor performs:
smoothing the first spectrum and the second spectrum in a frequency domain thereof; and
calculating a difference between the smoothed first spectrum and the smoothed second spectrum as the second conversion filter.

3. The voice processing apparatus according to claim 1, wherein the processor performs:
sequentially selecting a plurality of phonemes as the source voice, so that each phoneme selected as the source voice is processed by the processor to sequentially generate a plurality of phonemes as the target voice; and
connecting the plurality of the phonemes each generated as the target voice to synthesize an audio signal.

4. The voice processing apparatus according to claim 1, wherein the source feature of the source voice is provided in the form of a vector having components corresponding to coefficients of an autoregressive model that approximates an envelope of a spectrum of the source voice.

5. The voice processing apparatus according to claim 1, wherein the voice is divided into a plurality of unit periods, and the first conversion filter is generated by subtracting an envelope of the estimated spectrum from an envelope of the first spectrum at each unit period.

6. The voice processing apparatus according to claim 1, wherein the voice is divided into a plurality of unit periods, and the second conversion filter is generated by subtracting an envelope of the second spectrum from an envelope of the first spectrum at each unit period.

7. The voice processing apparatus according to claim 1, wherein the conversion function is set based on the source feature of the source voice which is provisionally sampled and a target feature of the target voice which is also provisionally sampled.

8. A voice processing method comprising the steps of:
generating a converted feature by applying a source feature of source voice to a conversion function for voice characteristic conversion, the conversion function including a probability term representing a probability that a feature of voice belongs to each element distribution of a mixture distribution model that approximates distribution of features of voices having different characteristics;
generating an estimated feature based on a probability that the source feature belongs to each element distribution of the mixture distribution model by applying the source feature to the probability term;
generating a first conversion filter based on a difference between a first spectrum corresponding to the converted feature and an estimated spectrum corresponding to the estimated feature;
generating a second spectrum by applying the first conversion filter to a source spectrum corresponding to the source feature;
generating a second conversion filter based on a difference between the first spectrum and the second spectrum; and
generating target voice by applying the first conversion filter and the second conversion filter to the source spectrum.

9. The voice processing method according to claim 8, wherein the step of generating a second conversion filter comprises:
smoothing the first spectrum and the second spectrum in a frequency domain thereof; and
calculating a difference between the smoothed first spectrum and the smoothed second spectrum as the second conversion filter.

10. The voice processing method according to claim 8, further comprising:
sequentially selecting a plurality of phonemes as the source voice, so that each phoneme selected as the source voice is processed to sequentially generate a plurality of phonemes as the target voice; and
connecting the plurality of the phonemes each generated as the target voice to synthesize an audio signal.

11. The voice processing method according to claim 8, further comprising the step of providing the source feature of the source voice in the form of a vector having components corresponding to coefficients of an autoregressive model that approximates an envelope of a spectrum of the source voice.

12. The voice processing method according to claim 8, wherein the voice is divided into a plurality of unit periods, and the step of generating a first conversion filter subtracts an envelope of the estimated spectrum from an envelope of the first spectrum at each unit period so as to generate the first conversion filter.

13. The voice processing method according to claim 8, wherein the voice is divided into a plurality of unit periods, and the step of generating a second conversion filter subtracts an envelope of the second spectrum from an envelope of the first spectrum at each unit period so as to generate the second conversion filter.

14. The voice processing method according to claim 8, further comprising the step of setting the conversion function based on the source feature of the source voice which is provisionally sampled and a target feature of the target voice which is also provisionally sampled.
